(19) United States
(12) Patent Application Publication
(10) Pub. No.: US 2021/0007283 A1
(43) Pub. Date: Jan. 14, 2021

(54) Harvesting Apparatus

(71) Applicant: CLAAS Saulgau GmbH, 88348 Bad Saulgau (DE)

(72) Inventor: Ulrich Boll, Bad Salgau (DE)

(21) Appl. No.: 16/923,507

(22) Filed: Jul. 8, 2020

(30) Foreign Application Priority Data
Jul. 10, 2019 (DE) 102019118737.0

(51) Int. Cl. A01D 80/00; A01D 78/00

(52) U.S. Cl. CPC A01D 80/00; A01D 78/002

(57) ABSTRACT

Harvesting apparatus, namely merger or pickup head, with a loadbearing frame (11) which has a longitudinal carrier (12) and crossmembers (13, 14, 24, 25), with a chassis (16) which has wheels (17), with receiving members (18) which are configured as a pickup for receiving harvested crops, one receiving member (18) on a first side of the longitudinal carrier (12) and a further receiving member (18) on a second side of the longitudinal carrier (12) being received in each case on a crossmember (13, 14), and with cross conveying devices (19) which are configured as belt conveyors for conveying the received harvested crops in a cross conveying direction which runs transversely with respect to a longitudinal direction, one cross conveying device (19) on a first side of the longitudinal carrier (12) and a further cross conveying device (19) on a second side of the longitudinal carrier (12) being received on the respective crossmember (13, 14), and it being possible for a transfer region (22) for the harvested crops to be configured between the cross conveying devices (19) which are arranged on different sides of the loadbearing frame (12). In the working position, the cross conveying devices (19) and receiving members (18) which are arranged on the different sides of the loadbearing frame (12) can be pivoted about in each case one pivot axis (28, 29) which extends in the longitudinal direction, the respective pivot axis (28, 29) being arranged in the region of the chassis (16) adjacently with respect to the transfer region (22).

The invention relates to a harvesting apparatus, namely a merger or pickup head, in accordance with the precharacterizing clause of claim 1.

EP 2 979 529 B1 has disclosed a harvesting apparatus which is configured as a merger. Mergers are also called pickup heads. In accordance with said prior art, the harvesting apparatus which is configured as a merger has a loadbearing frame and a chassis. Furthermore, the harvesting apparatus which is configured as a merger has receiving members which are configured as a pickup for receiving harvested crops, and cross conveying devices which are configured as belt conveyors for cross conveying the received harvested crops. The loadbearing frame has a longitudinal carrier and crossmembers, the receiving members and cross conveying devices being received on the crossmembers. The receiving members and cross conveying devices can be folded, in order to transfer the harvesting apparatus which is configured as a merger between a working position and a transport position.

When a harvesting apparatus which is configured as a merger assumes its working position and is pulled over ground to be worked via a towing vehicle, it has caused problems up to now for the harvested crops to be received completely and to be transported reliably via the cross conveying devices in the case of uneven ground. There is therefore a requirement for a harvesting apparatus which is configured as a merger or a pickup head and can be adapted simply to unevennesses of the ground to be worked, in order to achieve an optimum harvesting quality, that is to say in order to receive all harvested crops in an optimum manner and to cross convey them.

Proceeding herefrom, the present invention is based on the object of providing a novel harvesting apparatus which is configured as a merger or a pickup head.

Said object is achieved by way of a harvesting apparatus according to claim 1. According to the invention, in the working position, the cross conveying devices and receiving members which are arranged on the different sides of the loadbearing frame can be pivoted about in each case one pivot axis which extends in the longitudinal direction, the respective pivot axis being arranged in the region of the chassis adjacently with respect to the transfer region.

As a result of the embodiment according to the invention of the harvesting apparatus, the harvested crops can be received in an optimum manner and cross conveyed even in the case of uneven ground to be worked. The pivot axes which extend in the longitudinal direction and about which the receiving members and cross conveying devices can be pivoted in the case of ground following are arranged here adjacently with respect to the transfer region between the cross conveying devices which are positioned next to one another in the transverse direction. This has the advantage that as good as no vertical offset is caused between the cross conveying devices in the transfer region in the case of ground following. As a result, the crop flow of the harvested crops is not disrupted in the transfer region.

As viewed in the longitudinal direction, the respective pivot axis is preferably arranged between the wheels of the chassis. This arrangement of the pivot axes is particularly preferred, in order not to impair the transport of the harvested crops in the transfer region in the case of automatic ground following.

In accordance with one advantageous development, the harvesting apparatus has limiting devices for the pivoting movement of the cross conveying devices and receiving members which are arranged on the different sides of the loadbearing frame. The limiting devices also serve the purpose of designing the transport of the harvested goods in the transfer region in an optimum manner in the case of automatic ground following.

In accordance with one advantageous development, the chassis can be retracted and extended relative to the loadbearing frame for the transfer of the harvesting apparatus between a working position and a headland position. A damper is preferably arranged between the chassis and the loadbearing frame. The damper is active in the working position of the harvesting apparatus, and can likewise be utilized for optimum ground following.

Preferred developments of the invention result from the subclaims and the following description. Exemplary embodiments of the invention will be described in greater detail on the basis of the drawing, without being restricted thereto. In the drawing:

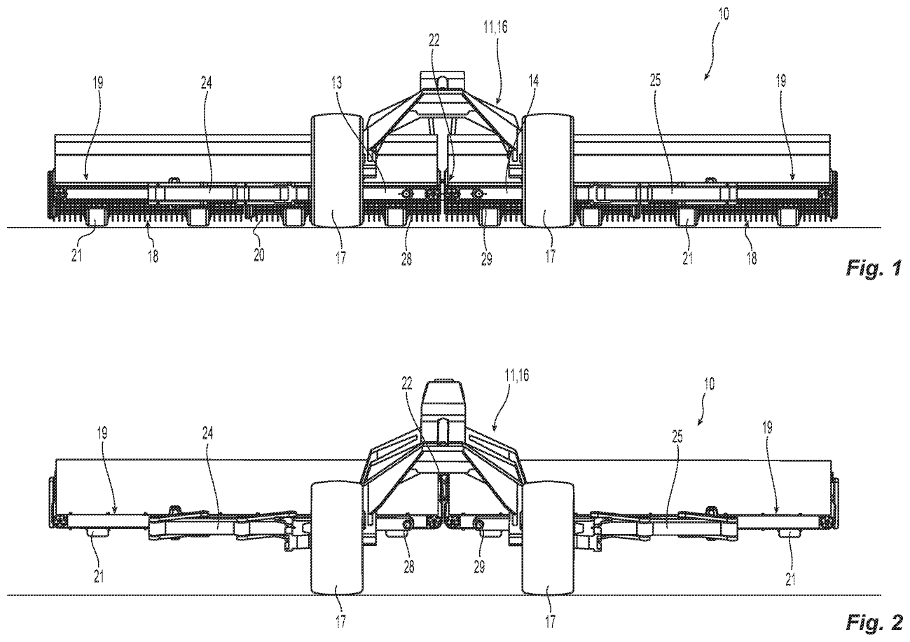

FIG. 1 shows a rear view of a harvesting apparatus which is configured as a merger or a pickup head in a working position,

FIG. 2 shows a rear view of the harvesting apparatus which is configured as a merger or a pickup head in a headland position,

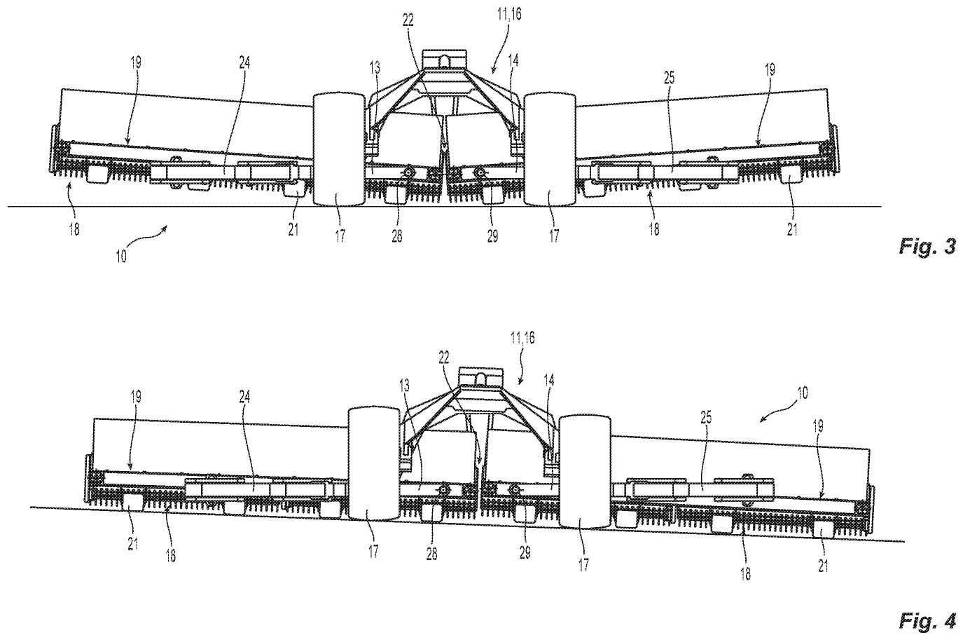

FIG. 3 shows a rear view of the harvesting apparatus which is configured as a merger or a pickup head in the working position with ground following,

FIG. 4 shows a rear view of the harvesting apparatus which is configured as a merger or a pickup head in the working position with ground following,

FIG. 5 shows a plan view of the harvesting apparatus which is configured as a merger or a pickup head,

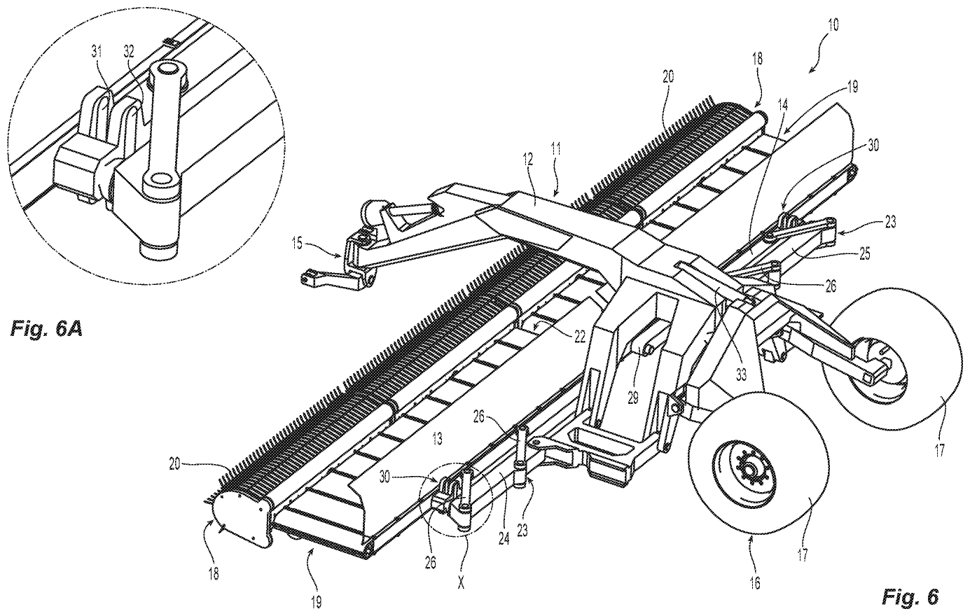

FIG. 6 shows a perspective view from above of the harvesting apparatus which is configured as a merger or a pickup head,

FIG. 6a shows the detail X from FIG. 6,

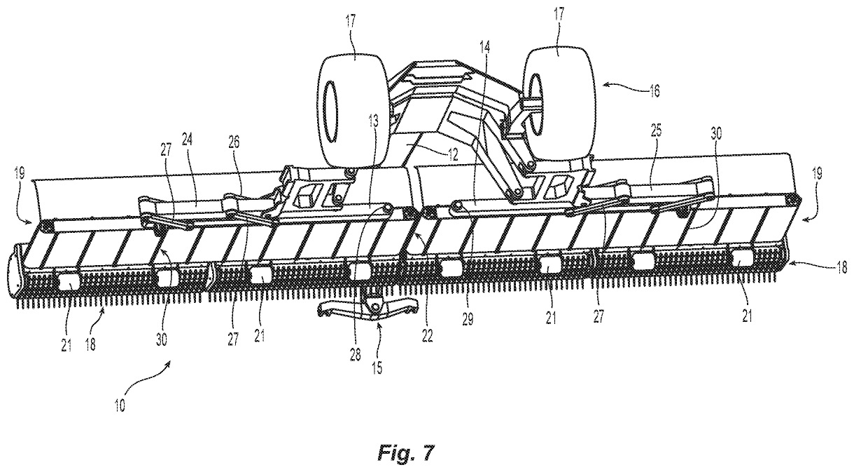

FIG. 7 shows a perspective view from below of the harvesting apparatus which is configured as a merger or a pickup head,

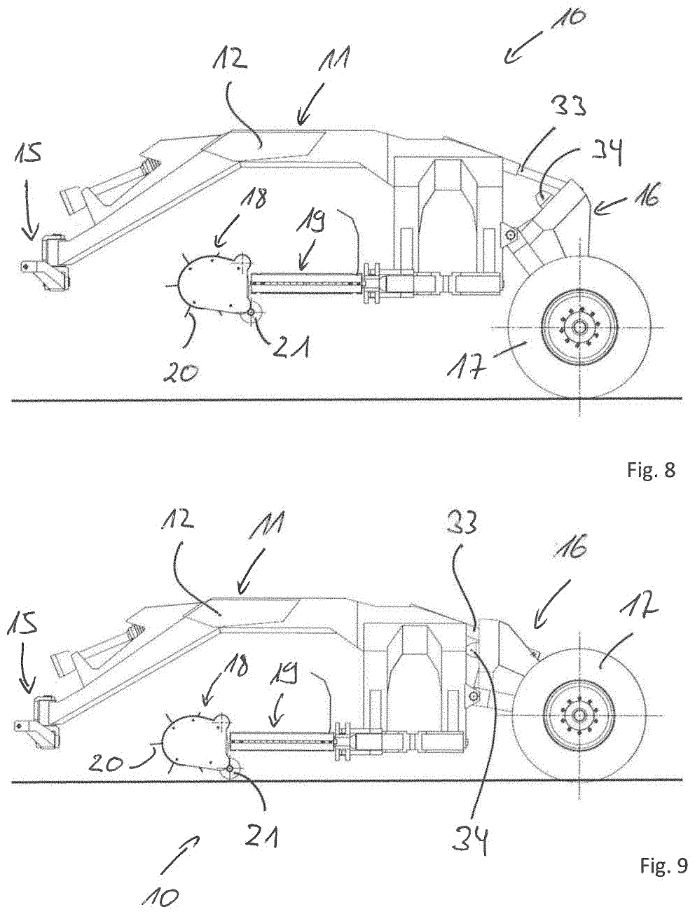

FIG. 8 shows a side view of the harvesting apparatus which is configured as a merger or a pickup head in the headland position,

FIG. 9 shows a side view of the harvesting apparatus which is configured as a merger or a pickup head in a working position,

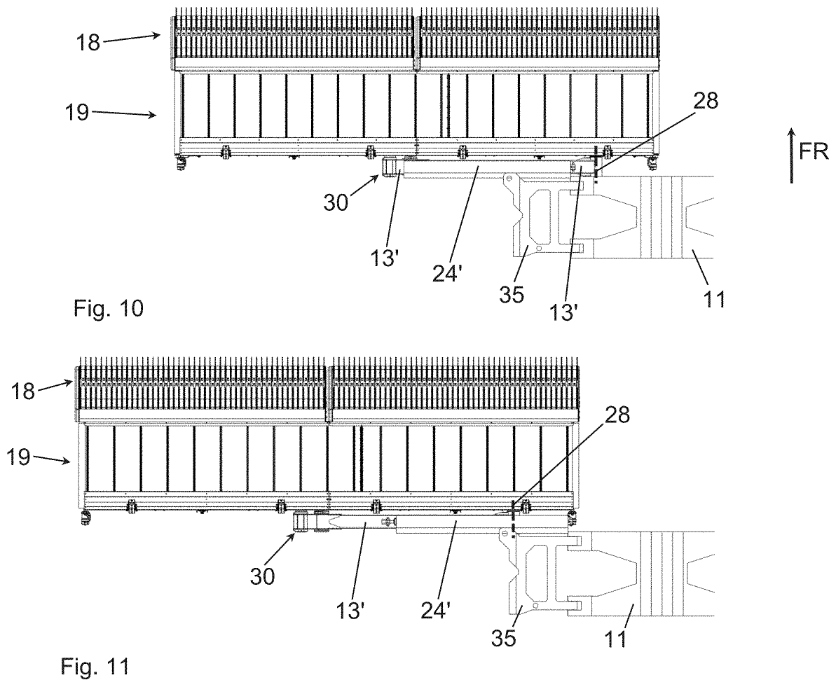

FIG. 10 shows a plan view of the left hand side of the harvesting apparatus, and

FIG. 11 shows a plan view of the left hand side of the harvesting apparatus in an extended position.

The invention relates to a harvesting apparatus which is configured as a merger. A harvesting apparatus of this type is also called a pickup head. FIGS. 1 to 4 show rear views, FIG. 5 shows a plan view, FIGS. 6 and 7 in each case show a perspective view, and FIGS. 8 and 9 in each case show side views of a harvesting apparatus 10 of this type which is configured as a merger.

The harvesting apparatus 10 has a loadbearing frame 11 with a longitudinal carrier 12 and crossmembers 13, 14, 24, 25. The harvesting apparatus 10 can be coupled to a towing vehicle (not shown) via the longitudinal carrier 12, namely of a coupling device 15 which is configured at the front end of the longitudinal carrier 12, in order to be pulled by the towing vehicle along ground to be worked. Here, the longitudinal carrier 12 extends in the towing direction or harvesting direction. The crossmembers 13, 14 extend transversely or perpendicularly with respect thereto.

Furthermore, the harvesting apparatus 10 has a chassis 16 with wheels 17. The chassis 16 is also called a main chassis.

Via the wheels 17 of the chassis 16, both in a working position (see FIGS. 1, 3, 4, 5, 6, 7 and 9) and in a transport position (not shown) and in a headland position (see FIGS. 2 and 8), the harvesting apparatus 10 which is configured as a merger is supported on the ground to be worked or to be travelled over.

Furthermore, the harvesting apparatus 10 has receiving members 18 and cross conveying devices 19.

The receiving members 18 are configured as what is known as pickups and serve to receive harvested crops from the ground to be worked. On a first side of the longitudinal carrier 12, a first receiving member 18 is received on the crossmember 13, and a second receiving member 18 is received on the crossmember 14 on a second side of the longitudinal carrier 12.

Here, the receiving members 18 have receiving prongs 20 which, in order to receive the harvested crops from the ground, are driven about an axis which extends in the transverse direction. In the working position of the harvesting apparatus 10, each of the receiving members 18 is supported via feeler wheels 21 on the ground to be worked. In a headland position (see FIGS. 2 and 9), the feeler wheels 21 are lifted up from the ground to be worked.

As has already been stated, the harvesting apparatus 10 has the cross conveying devices 19 in addition to the receiving members 18.

The cross conveying devices 19 are configured as belt conveyors, it being possible for the harvested crops which are received from the ground to be worked via the receiving members 18 to be transported via the cross conveying devices 19 in a cross conveying direction which extends transversely or perpendicularly with respect to the longitudinal direction.

On the first side of the longitudinal carrier 12, a first cross conveying device 19 is received on the first crossmember 13, and a second cross conveying device 19 is received on the second crossmember 14 on the second side of the longitudinal carrier 12, both of said cross conveying devices 19 being configured as belt conveyors.

As can be gathered from the drawings, the cross conveying devices 19 are arranged behind the receiving members 18 as viewed in the harvesting direction or towing direction of the harvesting apparatus.

In those positions of the harvesting apparatus 10 which are shown in the figures, the two cross conveying devices 19 which are configured as belt conveyors and are arranged on different sides of the longitudinal carrier 12 are pushed together or moved toward one another as viewed in the transverse direction with the minimization of the spacing between the cross conveying devices 19 and with the configuration of a transfer region 22 between the cross conveying devices 19. In the case of cross conveying devices 19 which are driven in the same direction, the harvested crops can be conveyed over the entire transverse extent of the harvesting apparatus 10 onto one side thereof. In this case, the harvested crops are then deposited laterally next to the harvesting apparatus 10 to form a swath on the ground.

In contrast to this, it is also possible that each of the cross conveying devices 19 which are configured as belt conveyors is moved away in each case in the transverse direction towards the outside from the longitudinal carrier 12, as a result of which a gap between the cross conveying devices 19 is then configured (not shown) with cancellation of the transfer region 22 between the cross conveying devices 19. In this case, in the case of cross conveying devices 19 which are driven in opposite directions, the harvested crops can then be combined to form what is known as a center swath in the region of said gap, and can be set down on the ground. In the case of said movement of the cross conveying devices 19, the receiving members 18 are also moved.

As has already been stated above, in each case one cross conveying device 19 and one receiving member 18 are received in the region of the two crossmembers 13, 14, it being possible, in the case of the above configuration or cancelation of the transfer region 22, for the crossmembers 13, 14 together with the receiving members 18 and the cross conveying devices 19 which are received thereon to be moved translationally in the transverse direction relative to further crossmembers 24, 25 of the loadbearing frame 11 via the kinematic link arrangement 23 which is shown, in particular, in FIGS. 5, 6 and 7. Each kinematic link arrangement 23 has upper links 26 and lower links 27 which act in an articulated manner on the respective crossmember 13, 24 and 14, 25, respectively, in order to ensure the translational displacement capability thereof in the transverse direction.

In order to make an optimum working result possible in the case of working of the ground to be worked in the working position of the harvesting apparatus 10, the receiving members 18 and the cross conveying devices 19 can be pivoted in the working position about pivot axes 28, 29 which extend in the longitudinal direction, for ground following of the harvesting apparatus, in particular for compensating of unevennesses of the ground to be worked. In the working position, the cross conveying devices 19 and receiving members 18 which are arranged on the different sides of the loadbearing frame 12 can be pivoted about in each case one pivot axis 28, 29 which extends in the longitudinal direction. The pivoting movement of the receiving members 18 and cross conveying devices 19 takes place relative to the crossmembers 13, 14, on which they are received.

The respective pivot axis 28, 29 is arranged adjacently with respect to the transfer region 22 of the cross conveying devices 19 in the region of the chassis 16. When the receiving members 18 and cross conveying devices 19 are pivoted about said pivot axes 28, 29 in the case of ground following, no vertical offset or at most a minimum vertical offset is configured between the cross conveying devices 19 in the transfer region 22. This can be gathered, in particular, from FIGS. 3 and 4 which show the harvesting apparatus 10 in the case of ground following, namely in the case of working of a well-like depression in the ground to be worked in FIG. 3, and in the case of working of ground which falls away on one side in FIG. 4.

For ground following, the cross conveying device 19 and receiving members 18 which are arranged on one side of the loadbearing frame 12 can be pivoted with respect to the cross conveying device 19 and receiving members 18 which are arranged on the other side of the loadbearing frame 12 independently of one another about the respective pivot axis 28, 29. This is shown, in particular, by FIG. 3.

As can be gathered from the figures, as viewed in the longitudinal direction, the respective pivot axis 28, 29, about which the receiving members 18 and cross conveying devices 19 can be pivoted in the working position for ground following, is arranged between the wheels 17 of the chassis 16. Here, an arrangement is preferred, in which the pivot axes 28, 29 are arranged in each case in the center between the transfer region 22 and the respective adjacent wheel 17 of the chassis 16 as viewed in the longitudinal direction, the respective pivot axis 28, 29 preferably being at a smaller spacing from the transfer region 22 than from the respective adjacent wheel 17 of the chassis 16. It is also possible, however, that a spacing of the respective pivot axis 28, 29 from the transfer region 22 is greater than a spacing of the respective pivot axis 28, 29 from the respective adjacent wheel 17 of the chassis 16, the pivot axes 28, 29 always being positioned, however, between the wheels 17 of the chassis 16, namely when, as viewed in the transverse direction, the cross conveying devices 19 are pushed together in the direction of the longitudinal carrier 12 with the configuration of the transfer region 22 and, accordingly, are at a minimum spacing in the transverse direction.

The pivoting movement of the respective receiving member 18 and the respective cross conveying device 19 is limited by way of a respective limiting device, the exemplary limiting device 30 having a slot 31 and a pin 32 which is guided in the slot 31 (see detail X in FIG. 6a). The slot 31 of the respective limiting device 30 can be a constituent part of the respective cross conveying device 19, and the pin 32 of said respective limiting device 30 can be a constituent part of the adjacent crossmember 13, 14. As an alternative, the pin 32 of the respective limiting device 30 can be a constituent part of the respective cross conveying device 19, and the slot 31 of said respective limiting device 30 can be a constituent part of an adjacent crossmember 13, 14.

In order to transfer the harvesting apparatus from the working position which is shown, in particular, in FIGS. 1, 3, 4 and 9 into the headland position which is shown in FIGS. 2 and 8, the chassis 16 can be retracted and extended relative to the loadbearing frame 11, to be precise by means of a hydraulic cylinder 33. In the retracted state of the hydraulic cylinder 33, the harvesting apparatus 10 assumes the working position and, in the extended state of the hydraulic cylinder 33, said harvesting apparatus 10 assumes the headland position.

A damper 34 which, according to FIG. 9, is active in the working position of the harvesting apparatus 10 is configured between the chassis 16 and the loadbearing frame 11. The damper 34 is preferably also active in the transport position, in particular in the case of a transport journey. Said damper 34 is an elastomerically deformable element which is mounted on the chassis 16 and is supported on the loadbearing frame 11 in the working position. As a result, during operation, the working position of the receiving members 18 and the cross conveying devices 19 is stabilized, in particular by virtue of the fact that forces and torques which act via the wheels 17 of the chassis 16 on the loadbearing frame 11 are damped.

As an alternative, the damper 34 can be arranged on the loadbearing frame 11 or a longitudinal carrier, and, as an alternative, springs, pneumatic spring elements or the like can be provided instead of elastomeric elements.

As an alternative to the above-described kinematic link system 23, a telescoping system can also be provided for the translational movement of the receiving members 18 and the cross conveying devices 19. FIG. 10 and FIG. 11 show a corresponding exemplary embodiment on the left hand machine side. The receiving member 18 and the cross conveying device 19 are articulated on a crossmember 13′ via the pivot axis 28 and the limiting device 30, and the crossmember 13′ is received on a further crossmember 24′ such that it can be displaced longitudinally.

The further crossmember 24′ preferably encloses the longitudinally displaceable crossmember 13′ merely in the upper and lower region. FIG. 10 shows the crossmember 13′ in the completely retracted state, and it can be seen that the crossmember 13′ projects at the two longitudinal ends of the crossmember 24′. FIG. 11 shows the crossmember 13′ in an approximately completely extended state. The crossmember 24′ is articulated via a vertical axis on an intermediate frame 35 which is in turn arranged on the loadbearing frame 11 via an axis which runs approximately in the driving or harvesting direction FR.

The invention allows optimum ground following in the case of a harvesting apparatus which is configured as a merger or a pickup head in the working position.

### LIST OF REFERENCE SIGNS

10 Harvesting apparatus
11 Loadbearing frame
12 Longitudinal carrier
13 Crossmember
13′ Crossmember
14 Crossmember
15 Coupling device
16 Chassis
17 Wheels
18 Receiving members
19 Cross conveying device
20 Receiving prongs
21 Feeler wheel
22 Transfer region
23 Kinematic link arrangement
24 Crossmember
24′ Crossmember
25 Crossmember
26 Link
27 Link
28 Pivot axis
29 Pivot axis
30 Limiting device
31 Slot
32 Pin
33 Hydraulic cylinder
34 Damper
35 Intermediate frame
FR Driving/harvesting direction

1. Harvesting apparatus, namely merger or pickup head,
with a loadbearing frame (11) which has a longitudinal carrier (12) and crossmembers (13, 14, 24, 25),
with a chassis (16) which has wheels (17),
with receiving members (18) which are configured as a pickup for receiving harvested crops,
one receiving member (18) on a first side of the longitudinal carrier (12) and a further receiving member (18) on a second side of the longitudinal carrier (12) being received in each case on a crossmember (13, 14),
with cross conveying devices (19) which are configured as belt conveyors for conveying the received harvested crops in a cross conveying direction which runs transversely with respect to a longitudinal direction, one cross conveying device (19) on a first side of the longitudinal carrier (12) and a further cross conveying device (19) on a second side of the longitudinal carrier (12) being received on the respective crossmember (13, 14), and it being possible for a transfer region (22) for the harvested crops to be configured between the cross conveying devices (19) which are arranged on different sides of the loadbearing frame (12), characterized in that,
in the working position, the cross conveying devices (19) and receiving members (18) which are arranged on the different sides of the loadbearing frame (12) can be pivoted about in each case one pivot axis (28, 29) which extends in the longitudinal direction, the respective pivot axis (28, 29) being arranged in the region of the chassis (16) adjacently with respect to the transfer region (22).

2. A harvesting apparatus according to claim 1, characterized in that, as viewed in the longitudinal direction, the respective pivot axis (28, 29) is arranged between the wheels (17) of the chassis (16).

3. A harvesting apparatus according to claim 1, characterized in that, as viewed in the longitudinal direction, the respective pivot axis (28, 29) is arranged in the center between the transfer region (22) and the respective adjacent wheel (17) of the chassis (16).

4. A harvesting apparatus according to claim 1, characterized in that, as viewed in the longitudinal direction, the respective pivot axis (28, 29) is arranged between the transfer region (22) and the respective adjacent wheel (17) of the chassis (16) in such a way that a spacing of the respective pivot axis (28, 29) from the transfer region (22) is smaller than a spacing of the respective pivot axis (28, 29) from the respective adjacent wheel (17) of the chassis (16).

5. A harvesting apparatus according to claim 1, characterized in that, as viewed in the longitudinal direction, the respective pivot axis (28, 29) is arranged between the transfer region (22) and the respective adjacent wheel (17) of the chassis (16) in such a way that a spacing of the respective pivot axis (28, 29) from the transfer region (22) is greater than a spacing of the respective pivot axis (28, 29) from the respective adjacent wheel (17) of the chassis (16).

6. A harvesting apparatus according to claim 1, characterized by limiting devices (30) for the pivoting movement of the cross conveying devices (19) and receiving members (18) which are arranged on the different sides of the loadbearing frame (12).

7. A harvesting apparatus according to claim 6, characterized in that the respective limiting device (30) comprises a pin (32) which is guided in a slot (31).

8. A harvesting apparatus according to claim 7, characterized in that the slot (31) of the respective limiting device (30) is a constituent part of the respective cross conveying device (19), and the pin (32) of said respective limiting device (30) is a constituent part of an adjacent crossmember (13, 14).

9. A harvesting apparatus according to claim 7, characterized in that the pin (32) of the respective limiting device (30) is a constituent part of the respective cross conveying device (19), and the slot (31) of said respective limiting device (30) is a constituent part of an adjacent crossmember (13, 14).

10. A harvesting apparatus according to claim 9, characterized in that the chassis (16) can be retracted and extended relative to the loadbearing frame (11) for the transfer of the harvesting apparatus between a working position and a headland position.

11. A harvesting apparatus according to claim 1, characterized by a damper (34) between the chassis (16) and the loadbearing frame (11).
